(19) United States
(12) Patent Application Publication
(10) Pub. No.: US 2013/0306179 A1
(43) Pub. Date: Nov. 21, 2013

(54) HYDRAULIC CONTROL BLOCK

(71) Applicants: Michael Godzik, Schweinfurt (DE); Robert Rueppel, Bischbrunn (DE); Thilo Steigerwald, Partenstein (DE)

(72) Inventors: Michael Godzik, Schweinfurt (DE); Robert Rueppel, Bischbrunn (DE); Thilo Steigerwald, Partenstein (DE)

(21) Appl. No.: 13/881,755

(22) PCT Filed: Oct. 7, 2011
(86) PCT No.: PCT/EP2011/004997

§ 371 Date: Aug. 7, 2013

(30) Foreign Application Priority Data
Oct. 28, 2010 (DE) 10 2010 049 990.0

(51) Int. Cl. F15B 21/00

(52) U.S. Cl. CPC F15B 21/00
USPC 137/884

(57) ABSTRACT

A hydraulic control block includes a plurality of valve segments lying on top of one another. A control piston arranged in each valve segment is configured to control inflow of hydraulic oil from a pressure source to a load or discharge of hydraulic oil from a tank. Each control piston is hydraulically operable by at least one pilot valve and each pilot valve is electromagnetically operable. The hydraulic circuits formed in the valve segments are preloaded to a preload pressure corresponding to a respective ambient pressure. The pilot valves are arranged in a housing sealed off from surroundings. The housing interior is filled with hydraulic oil and is connected to the tank. The pilot valves assigned to each valve segment are attached directly to the valve segments, are arranged in their own housing sealed off from surroundings, and are connected to a tank line leading to the tank.

The invention relates to a hydraulic control block which has a plurality of valve segments lying one on top of the other wherein a control piston is arranged in each valve segment and controls the inflow of hydraulic oil from a pressure source to a load or the discharge of hydraulic oil from a load to a tank wherein each control piston is operable hydraulically in each case by one or a plurality of pilot valves and each pilot valve is operable by an electromagnet, and wherein the hydraulic circuits formed in the valve segments including the feeds to the tank(s) and to the load(s) and also the tank(s) and the load(s) are preloaded to a preload pressure corresponding to the respective ambient pressure, and also the pilot valves are arranged in a housing that is sealed off with respect to the surroundings, the interior of which is filled with hydraulic oil and is connected to the tank.

The preload pressure is generated by a pressure compensator which is connected to the tank. The preload pressure is always slightly greater than the ambient pressure in which the hydraulic control block is located.

Hydraulic control blocks of this kind are used for example in marine areas, in off-shore projects and in particular deep-sea hydraulics.

The preload pressure in the hydraulic circuits, the tank and the loads thereby takes care of the differential pressures required for an ability to function.

Furthermore penetration of for example sea water into the hydraulic control block is thereby prevented.

For this it is known to arrange a preload unit comprising pilot valves mounted in a common housing on the control block which is formed by the valve segments and to connect the housing which is filled with preloaded oil to the tank pipe of the system.

The connection between the pilot valves and the valve segments takes place via hoses or pipelines.

This design requires a large amount of space and a heavy weight.

Furthermore the cost of the hoses or piping between the pilot valves and the valve segments is very high since each valve segment requires two control lines.

The object of the invention is therefore to provide a hydraulic control block of the type mentioned at the beginning which avoids the aforementioned drawbacks, is suitable for use under water, particularly in deep-sea hydraulics, and has a compact as well as flexibly variable structure.

This is achieved according to the invention in that the or each pilot valve is connected directly to each valve segment associated with it and these pilot valves connected to a valve segment are arranged in their own housing which is sealed from the surroundings and are also connected to a tank line leading to the tank.

Through directly connecting the pilot valves to the valve segments it is possible to dispense with hose or pipe connections between the pilot valves and the valve segments whereby the cost of assembly and the number of possible leakage sites is kept small.

The pressure compensation of the housing enables underwater use, in particular also deep-sea use.

Since there is no requirement for a precontrol unit fixed in its structure there is also no need for any expensive individual control blocks designed to fit same, but different valve segments can be assembled kit-like into one control block. Thus standard valve segments and standard housings can be used cost-effectively and flexibly. Avoiding hose and pipe connections, one channel can be formed in each valve segment to lead from inside the associated housing to the tank line.

Each channel can thereby be guided to its own tank line.

If the tank lines of several valve segments are arranged coaxially relative to one another forming a single tank line which extends through several valve segments, then the valve segments can have a smaller weight-saving structural size.

Furthermore saving component parts and reducing the structural size, the housing can in a double function be the pilot valve housing of the pilot valves.

To save energy and control the pilot valves one or more housings preferably have an electrical underwater plug connector which produces a sealed electrical connection from outside the housing to inside the housing and from which an electric lead leads to the electromagnet of the pilot valve, whereby the ability to flexibly combine the control blocks is assisted.

A simple and rapid ventilation and filling of the housing with hydraulic oil is possible in that one or more housings has/have a tightly closable filling and/or ventilation opening.

Embodiments of the invention are shown in the drawings and will be described in further detail in the following. In the drawings:

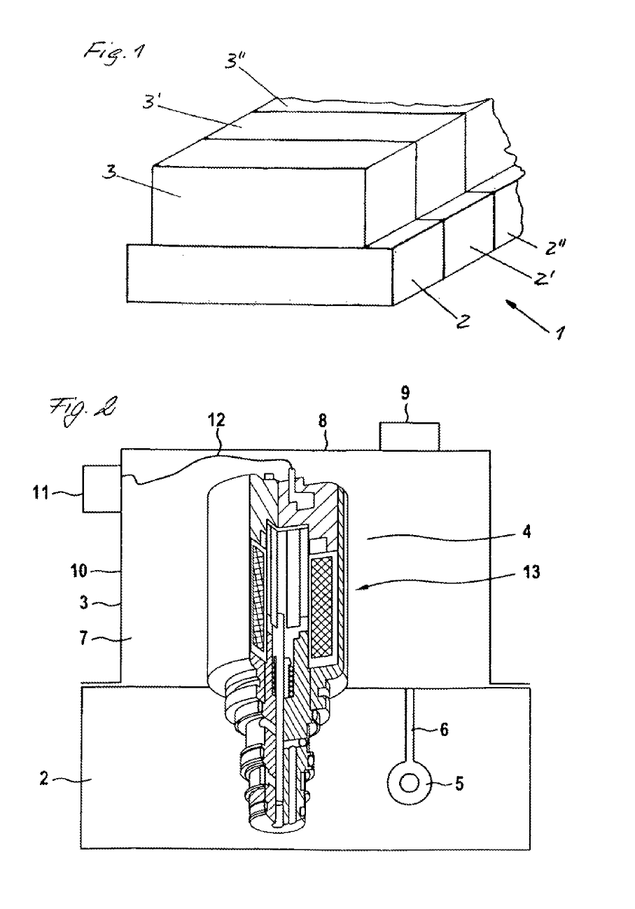

FIG. 1 shows a perspective schematic diagram of a hydraulic control block with pilot valves;

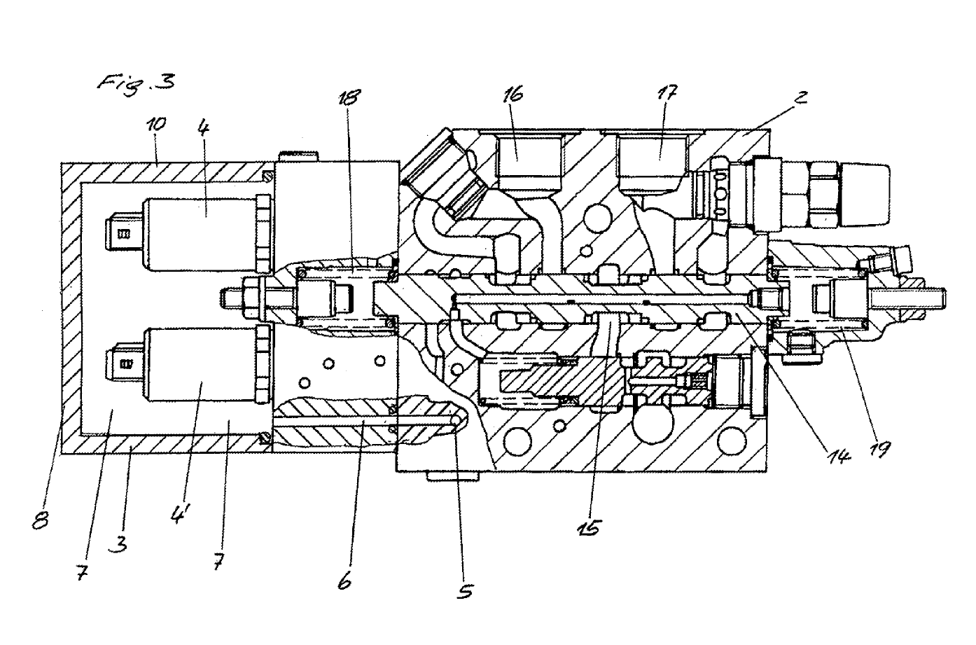

FIG. 2 shows a schematic diagram of a valve segment provided with a pilot valve;

FIG. 3 shows a longitudinal sectional view through a valve segment of a control block with pilot valves.

FIG. 1 shows a hydraulic control block 1 which consists of several valve segments 2, 2′, 2″ lying one on top of another and detachably connected to one another.

A housing 3, 3′, 3″ is fixed on each valve segment 2, 2′, 2″, and one or several pilot valves assigned to each relevant valve segment 2, 2′, 2″ are mounted in the housing.

FIG. 2 shows symbolically a valve control segment 2 having a pot-shaped housing 3 fixed tightly thereon and in which a pilot valve 4 is mounted.

A tank line 5 is formed in the valve segment 2 and leads to a tank (not shown) for the hydraulic oil in which a preload pressure corresponding to the relevant ambient pressure prevails.

A channel 6 formed in the valve segment 2 leads from the tank line 5 to the interior 7 of the housing 3 so that the pressure of the tank also prevails in the interior 7 of the housing 3.

For a simple ventilation and filling of the housing 3 with hydraulic oil the housing 3 has a closable filling and ventilation opening 9 in its upwardly directed base 8.

Furthermore on the side wall 10 of the housing 3 there is an electrical underwater plug connector 11 into which a plug can be inserted from outside and from which inside the interior 7 of the housing 3 an electric lead 12 leads to an electromagnet 13 of the pilot valve 4.

The supply of energy and the control of the electromagnet 13 can thereby take place from outside even when the valve segment 2 is located with the pilot valve 4 under water.

FIG. 3 shows a valve segment 2 of a multi-way valve in which a control piston 14 is mounted displaceably and through which a feed connection 15, connected to a pressure source (not shown) such as for example a hydraulic pump, is connectable to a flow connection 16, which leads to a load (not shown) such as for example a hydraulic cylinder, or a return flow connection 17.

The control piston 14 which can be held in its neutral position by springs 18, 19 is displaceable from the neutral position into these two working positions by a first pilot valve 4 and a second pilot valve 4′.

The two pilot valves 4, 4′ are installed directly on the valve segment 2 and are surrounded by a pot-like housing 3 which is connected tightly to the valve segment 2.

A channel 6 leads to the interior 7 of the housing 3 from a tank line 5 which is formed in the valve segment 2 and leads to a tank (not shown).

Since the tank as well as the hydraulic circuits of the valve segment 2 are filled with hydraulic oil and are preloaded under a preload pressure corresponding to the ambient pressure, the interior 7 of the housing 3 which is likewise filled with hydraulic oil also stands under this preload.

Thus during use under water no water can penetrate into the valve segment 2, the tank or the housing 3.

This also not even when the entire assembly is located in a deep-sea use. The preload pressure in the valve segment 2, tank and housing 3 need only be corresponding to the ambient pressure at the useage site.

### LIST OF REFERENCE NUMERALS

1 Control block
2 Valve segment
2′ Valve segment
2″ Valve segment
3 Housing
3′ Housing
3″ Housing
4 Pilot valve
4′ Pilot valve
5 Tank line
6 Channel
7 Interior
8 Base
9 Ventilation and filling opening
10 Side wall
11 Underwater plug connector
12 Lead
13 Electromagnet
14 Control piston
15 Feed connection
16 Inflow connection
17 Return flow connection
18 Spring
19 Spring

1. A hydraulic control block comprising:
several valve segments lying on top of one another;
a control piston arranged in each valve segment and configured to control an inflow of hydraulic oil from a pressure source to at least one load and/or a discharge of hydraulic oil from at least one load to at least one tank, each control piston configured to be operated hydraulically by at least one pilot valve, and each pilot valve configured to be operated by an electromagnet; and
hydraulic circuits formed in the valve segments and including feeds to the at least one tank, feeds to the at least one load, the at least one tank and the at least one load, the hydraulic circuits being preloaded to a preload pressure corresponding to a respective ambient pressure,
wherein the at least one pilot valve of each control piston is arranged in a respective housing that is sealed off with respect to surroundings, an interior of the respective housing being filled with hydraulic oil and connected to the at least one tank, and
wherein the at least one pilot valve assigned to each valve segment is attached directly to a respective valve segment, and the at least one pilot valve attached to the respective valve segment is arranged in the respective housing which is sealed off with respect to the surroundings, and the at least one pilot valve attached to the respective valve segment is connected to a respective tank line leading to the at least one tank.

2. The hydraulic control block as claimed in claim 1, further comprising:
a channel formed in each valve segment and configured to lead from the interior of the respective housing to the respective tank line.

3. The hydraulic control block as claimed in claim 2, wherein the respective tank line of several valve segments are arranged coaxially relative to one another to form a single tank line configured to extend through the several valve segments.

4. The hydraulic control block as claimed in claim 1, wherein the respective housings are pilot valve housings of the pilot valves.

5. The hydraulic control block as claimed in claim 1, wherein:
one or more respective housings have an electrical underwater plug connector configured to produce a sealed electrical connection from outside of the respective housing to the interior of the respective housing and have an electric lead configured to lead from the underwater plug connector to the electromagnet of the at least one pilot valve.

6. The hydraulic control block as claimed in claim 1, wherein one or more respective housings have a tightly closable opening configured for at least one of filling and ventilation.
